(19) United States
(12) Patent Application Publication
(10) Pub. No.: US 2015/0370761 A1
(43) Pub. Date: Dec. 24, 2015

(54) DISPLAY LAYOUT EDITING SYSTEM AND METHOD USING DYNAMIC REFLOW

(71) Applicant: Keepsayk LLC, Glen Ellyn, IL (US)

(72) Inventors: Kimberly Harrod, Glen Ellyn, IL (US); Steven Landers, Mount Claremont (AU)

(21) Appl. No.: 14/749,462

(22) Filed: Jun. 24, 2015

Related U.S. Application Data
(60) Provisional application No. 62/016,590, filed on Jun. 24, 2014.

(51) Int. Cl. G06F 17/21

(52) U.S. Cl. CPC G06F 17/217

(57) ABSTRACT

A system and method for page layouts using dynamic reflow are disclosed. Embodiments of the system and method provide features that can allow the user of a small mobile device to be able to quickly and easily create and/or edit page layouts for digital scrapbooks.

### PRIORITY CLAIM/RELATED APPLICATION

This application claims the benefit under 35 USC 119(e) and priority under 35 USC 120 to U.S. Provisional Patent Application Ser. No. 62/016,590 filed on Jun. 24, 2015 and entitled “Display Layout Editing Through Dynamic Reflow”, the entirety of which is incorporated herein by reference.

### FIELD

The disclosure relates generally to a layout tool and in particular to a layout tool system and method for a digital book system.

### BACKGROUND

An increasingly-growing number of applications exist for managing and sharing photos and other media. Many of these applications are directed towards helping users create book-like layouts of images and text passages, typically for printing. The task of manipulating the designs for layout of such pages often involves difficult multi-step processes, complicated tools, and large displays.

Because of these factors, such existing applications can be ill-suited for use on small mobile devices. Further, when implemented on touch-based devices, their complicated interfaces require concerted effort, typically using both hands, for the user to perform the various editing functions to create the desired result.

The existing systems may not be very useful for enabling the user to quickly create and edit digital scrapbook page layouts on small mobile devices, such as phones or small tablets, where one-handed operation is often desirable, and where easy-to-use interfaces are needed.

### BRIEF DESCRIPTION OF THE DRAWINGS

A further understanding of the nature and the advantages of particular embodiments disclosed herein may be realized by reference of the remaining portions of the specification and the attached drawings.

FIG. 1 illustrates an example of content system that may utilize layout editing with dynamic reflow;

FIG. 2 illustrates an example of a layout editing method with dynamic reflow;

FIG. 3 shows a first image layout pattern;

FIG. 4 shows a second image layout pattern;

FIG. 5 shows a third image layout pattern;

FIG. 6 shows a fourth image layout pattern;

FIG. 7 shows a fifth image layout pattern; and

FIG. 8 shows a sixth image layout pattern.

### DETAILED DESCRIPTION OF ONE OR MORE EMBODIMENTS

One embodiment allows the user generate layout designs on small portable electronic devices such as Apple® iPhone® and iPod® Touch. Although specific devices and user input mechanisms may be described, it should be apparent that embodiments can be implemented on other computing devices and with alternate input mechanisms. For example, the computing device may be mobile phones, tablets, laptops, phablets, music players, portable game devices, etc., may be used. Similarly, touch screens, gesture recognition, voice commands, and other forms of user input may be employed. In general, any type of suitable platform can be used using any suitable hardware or software.

The system and method provide features that can allow the user of a computing device, such as a small mobile device, to be able to quickly and easily create and/or edit page layouts for digital books of content having a plurality of pages, such as digital scrapbooks. The system may also allow the books to be shared directly from the computing device after creation.

One embodiment provides a method for manipulating images, the method comprising the following acts performed by one or more processors: accepting a signal from a user input device to select a page layout; displaying a first group of images using the selected page layout; and displaying a second group of images using a different page layout in response to the selection of the selected page layout.

Another embodiment provides an apparatus for manipulating images, the apparatus comprising: one or more processors coupled to a non-transitory medium including instructions executable by the processors for: accepting a signal from a user input device to select a page layout; displaying a first group of images using the selected page layout; and displaying a second group of images using a different page layout in response to the selection of the selected page layout.

Another embodiment provides a non-transitory medium including instructions executable by one or more processors for: accepting a signal from a user input device to select a page layout; displaying a first group of images using the selected page layout; and displaying a second group of images using a different page layout in response to the selection of the selected page layout. Now, an example of an implementation of a system that provide layout editing with dynamic reflow is described.

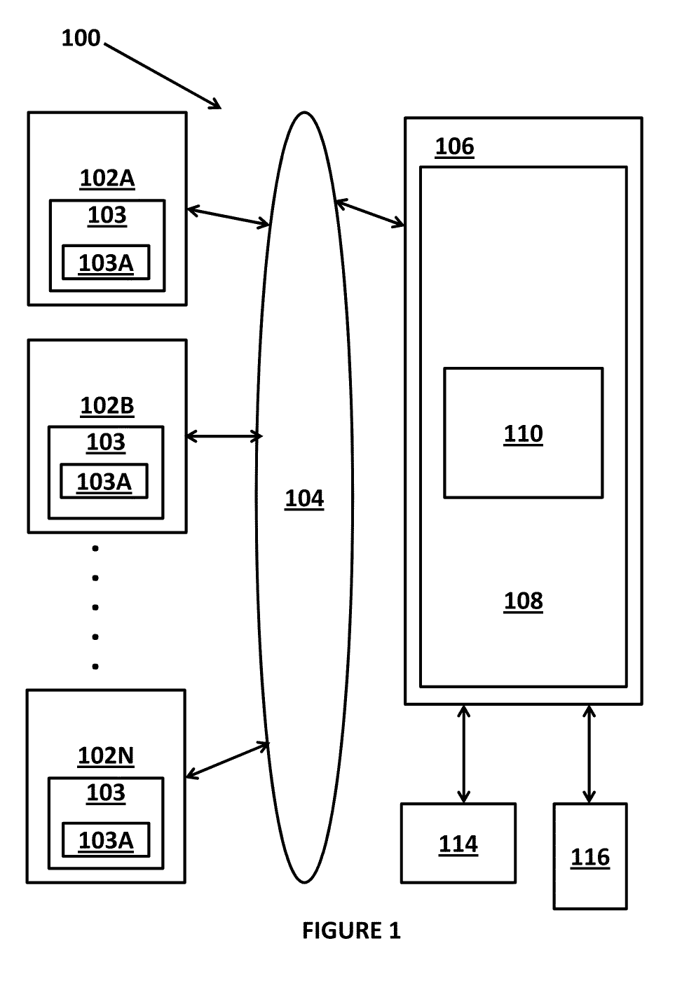

FIG. 1 illustrates an example of content system 100 that may utilize layout editing with dynamic reflow. The system 100 may include one or more computing devices 102, such as 102A, 102B, . . . , 102N as shown in FIG. 1, that connect to and exchange data over a communications path 104 with a backend component 106 that may provide one or more cloud services including a content service. Each computing device 102 may have an application 103 resident on the computing device that is executed by a processor of the computing device to interact and exchange data with the backend component 106. The application 103 may be a browser application, a mobile application or an application downloaded from the backend component 106. The application 103 may include a dynamic reflow component 103A that allow the user of a computing device, such as a small mobile device, to be able to quickly and easily create and/or edit page layouts for books of content having a plurality of pages, such as digital scrapbooks as described below in more detail.

Each computing device 102 may be a client that communicates with and uses the one or more cloud services, such as a content service 108. Each computing device 102 may be a processor based device with at least one processor, memory, persistent storage, a display and connectivity circuits that can be used by a user to connect to and interact with the backend and the one or more cloud services. For example, each computing device may be a smartphone device, such as an Apple® iPhone® or an Android® operating system based device, a mobile device, a tablet computer device, a personal computer device, a terminal device, a laptop computer device and the like. The application 103 may be a plurality of lines of computer code that may be executed by the processor of the computing device 102. In one example of the system when used for a digital scrapbooking cloud service, the application may be a Keepsayk™ app that is described in more detail below.

The communications path 104 may be a wired communications path or wireless communications path or a combination of the two. For example, the communication path 104 may be Ethernet, a wireless data network, a wireless computer data network, a wireless cellular data network, a computer data network and the like. The communication path may use various communication protocols, such as HTTP or HTTPS as well as various data transfer protocols, such as HTML, JSON to provide the communication path between the one or more computing devices 102 and the one or more cloud services hosted by and provided by the backend 106.

The backend component 106 may include a digital book cloud services component 108 and the digital book cloud service component 108 may further have a web server/API server component 110 wherein the components of the content cloud services component 108 communicate with each computing device 102 and provide the book cloud service to each computing device 102. For example, the digital book cloud services component 108 may electronically distribute digital books generated by a user, manage the storage of the digital content for the digital books as well as the assembled digital books, and store the digital content for the digital books as well as the assembled digital books. The backend component and its components may be implemented using one or more computing resources such as server computers, processors, memory, persistent storage components, blade computers and the like. Each of the components 108, 110 may be implemented in hardware or software. When a component is implemented in software, the component may be a plurality of lines of computer code that may be executed by a processor so that the processor is configured to perform the operations and functions of those components as described below. When a component is implemented in hardware, the component is a circuit, such as a programmable logic device, microcontroller, application specific integrated circuit and the like, that performs the operations and functions of those components as described below.

The backend component 106 may be capable of connecting with and exchanging data with one or more other systems. For example, the backend component may be coupled to a data storage system 114 that may be a database server and a third party data storage system 116 as shown. The third party data storage system 116 allows the system to build, deploy, and scale online cloud-based web applications/cloud services without necessarily requiring large investments in hardware infrastructure and network bandwidth.

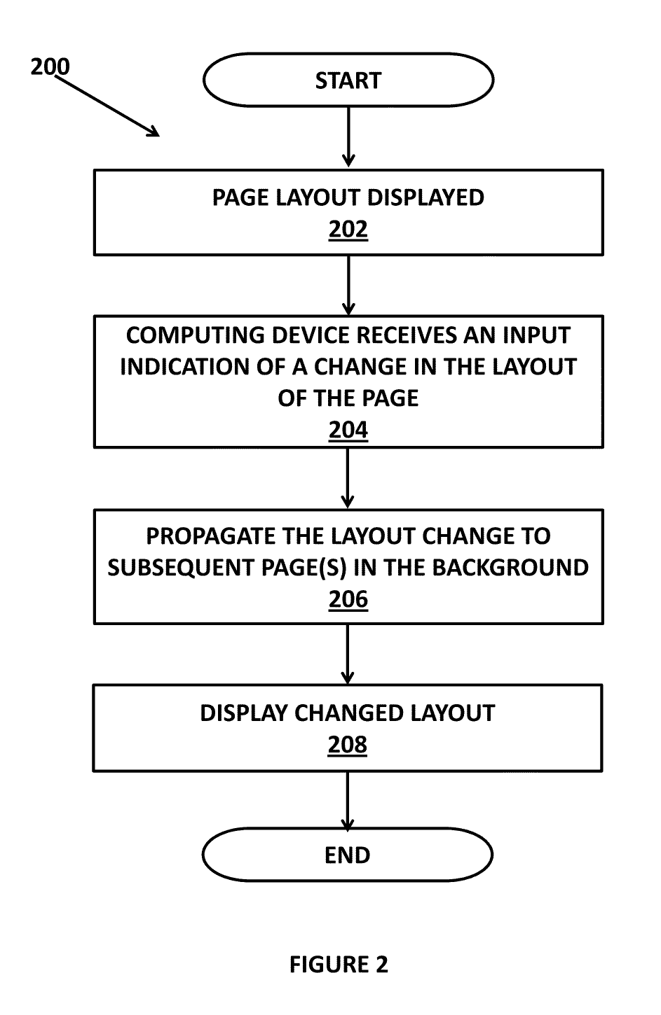

The web/API server component 110 may receive data requests for each computing device (and more specifically each application 103 of each computing device) and exchange data with each computing device as described below with reference to FIG. 2. The web/API server component 110 also may respond to the data requests and provide code and data identifiers for the requested data.

FIG. 2 illustrates an example of a layout editing method 200 with dynamic reflow. In one embodiment, the method shown in FIG. 2 may be implemented by the dynamic reflow component 103A and the application 103 on each computing device. Specifically, the processor of each computing device may execute the plurality of instructions of the dynamic reflow component 103A so that the processor is configured to perform the processes shown in FIG. 2. The method may also be performed in other manners that are within the scope of the disclosure.

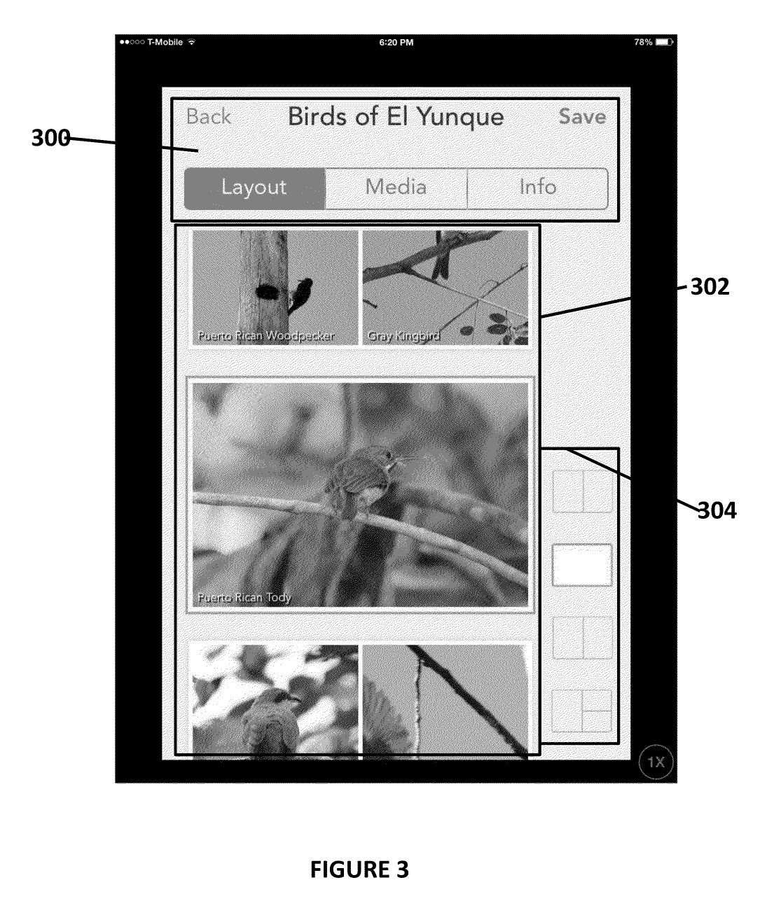

In the method, a page layout is displayed (202) on the computing device. Examples of the page layout display are shown in FIGS. 3-8. The page layout may be for a book, such as a digital scrapbook. Although the examples of the page layouts show images, the system and method more generally may be used for any type of media or digital content, such as video, text, document, slide, etc. As shown in FIG. 3, the page layout may include a command portion 300 that allows the user to select between different functions of the application 103 including the page layout. The page layout further includes a layout display portion 302 that shows the current page layout for the current page and one or more subsequent pages and a layout schematic portion 304 that displays the types of different layouts that may be selected by the user.

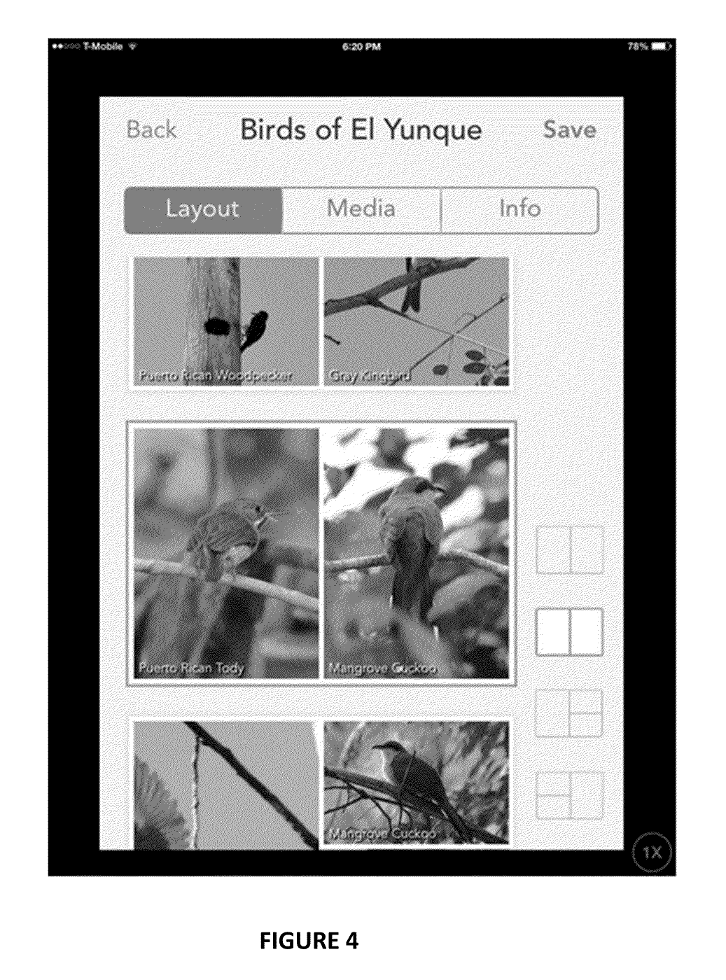

In the application 103, when a user taps on content in the layout display portion 302 or the layout schematic portion 304, the layout for the current page may be changed by the application and the computing device receives an input indication of the change in layout (204). In the method, the page layout may move through a sequence of layouts, one for each tap, for that page. Thus, for example, when the first tap (and input indication to the computing device) the page layout may transition from a first layout (shown in FIG. 3) to a second layout (shown in FIG. 4.)

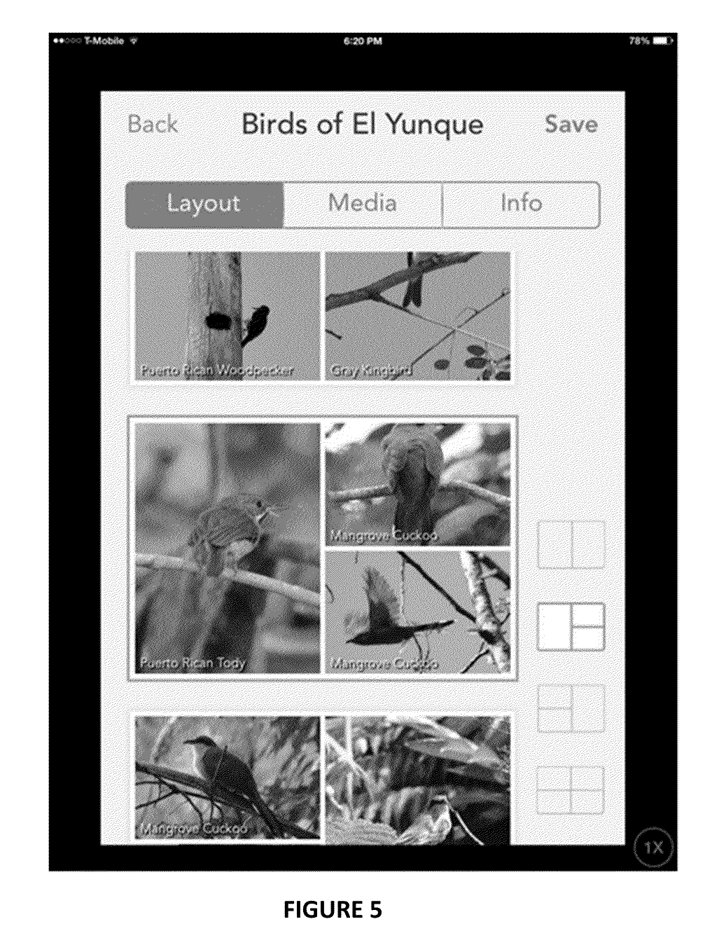

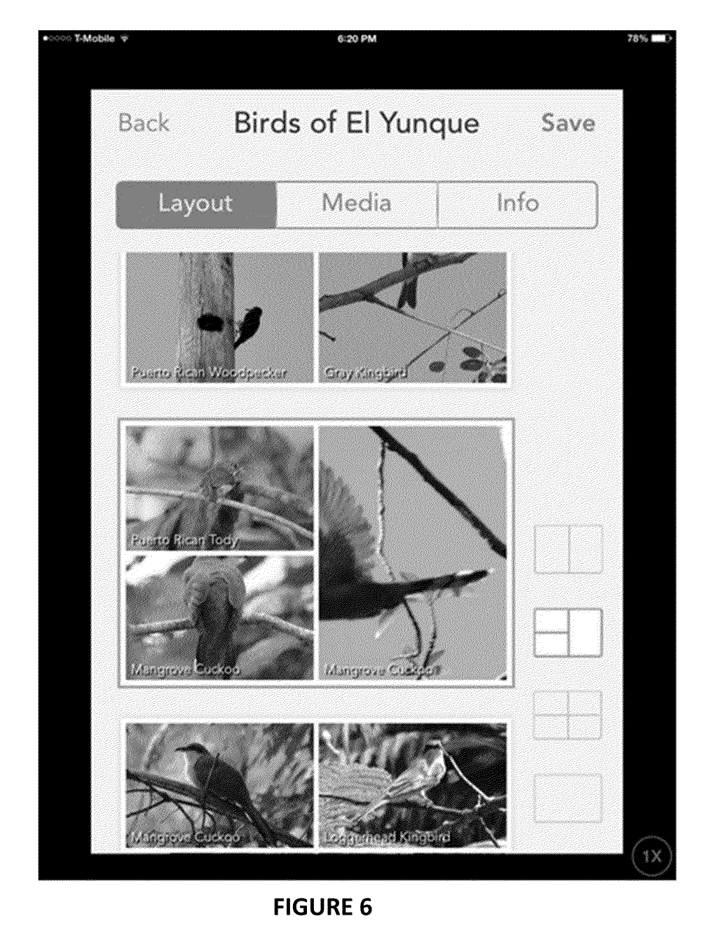

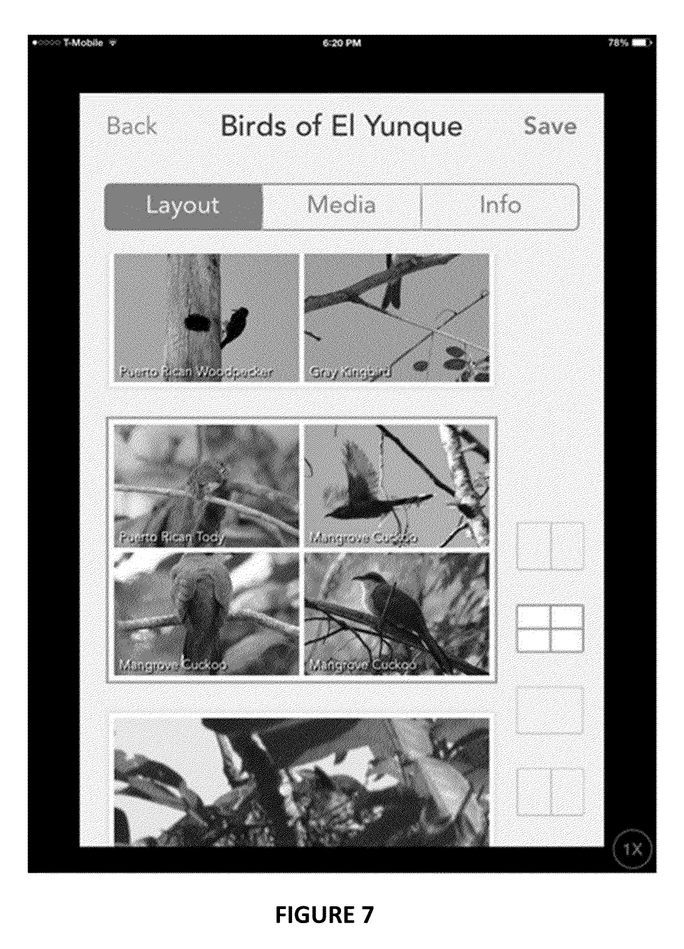

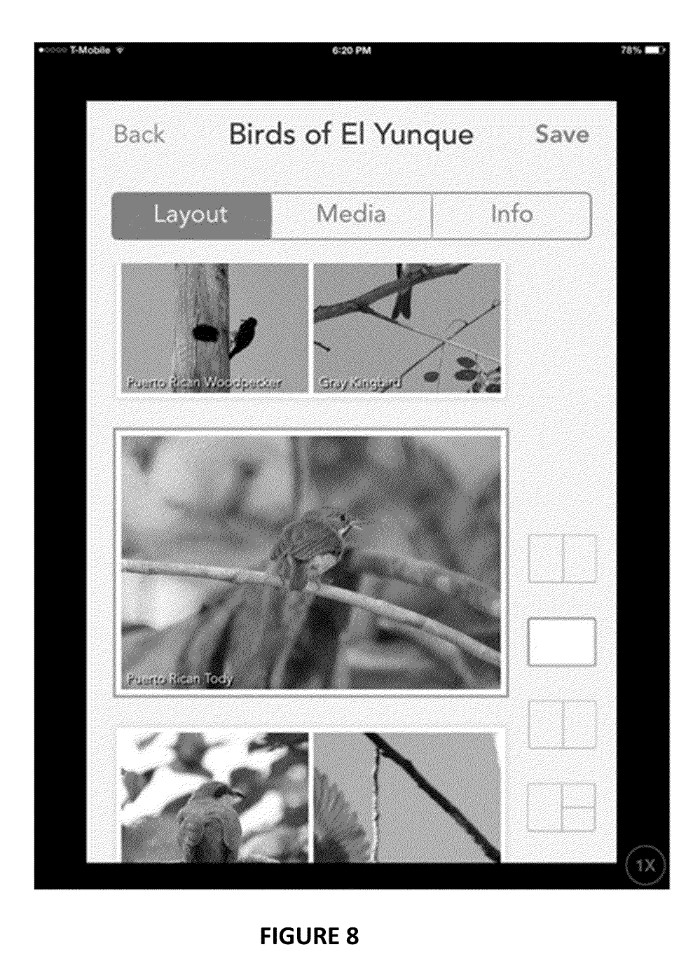

In one example, the page layouts may be internally numbered 1 to 5. Layout One is a single landscape image (FIG. 3). Layout Two contains two side-by-side portrait images (FIG. 4). Layout Three positions one portrait image on the left and two quarter-page-size landscape images on the right (FIG. 5). Layout Four positions two landscape images on the left and one portrait image on the right (FIG. 6). And Layout Five positions four quarter-page-sized landscape images on the page, in a 2×2 grid pattern (FIG. 7). Tapping again causes the sequence to cycle back to Layout One again as shown in FIG. 8. However, the page layout editing system and method is not limited to the different layouts in FIGS. 3-8 and the page layout editing system and method may be implemented using less or more different page layouts. Thus, in the example, FIGS. 3-8 shows an example of a progression of layout incrementing and propagation that takes place as the user taps repeatedly on the selected page.

The layout change may be automatically and dynamically propagated to the subsequent pages of the book (206) in the background which is part of the dynamic reflow process. The application 103 may also display the changed layout (208). Assuming that the book has 10 pages and the user is currently viewing the layout of page 4, pages 1-3 may be referred to as upstream page(s) (one or more pages in the book before the selected page) and pages 5-10 may be referred to a downstream page(s) (one or more pages in the book after the selected page.) Thus, the process 206 reflows the content into the new layout positions downstream from the selected page, but upstream pages are unaffected. This is done by incrementing a sequence number (the Layout number described above) for the current page, and then incrementing the sequence number for each subsequent page, so that each of these subsequent pages has one added to its sequence number as well. This results in a default layout scheme where each page has a different layout pattern than the preceding page. The changing of the layouts may be animated to show the movement of the content on each page into the new positions so that the user has good visual feedback that a reflow event has occurred.

In order to optimize the processor load of the computing device for very large books, such as very large scrapbooks, the reflow animations described above may be performed first for only the two affected pages visible on the screen (the current selected page and the immediately subsequent page), then the remainder of the book is reflowed in the background. With this approach, even books with 1000 pieces of content or more can be reflowed instantly with a single tap. In other embodiments, more or less pages and layout patterns can be displayed on the screen at any given time. A user may use standard types of user interface features such as zooming, panning/scrolling, etc. Different methods of rendering pages and performing background processing can be used.

Once the user has settled on the desired layout design for the selected page, then the page images can be scrolled to the next page, and the process shown in FIG. 2 can be repeated. The user can repeat this process very quickly and easily as each page is stepped through, all via the action of a single finger or thumb. When the user is satisfied with all the changes to the scrapbook, the Save button in the command portion 300 can be tapped, to save the changes.

If the user has manually reflowed the layouts from a position within the book, using the mechanism described above, then moves back to an upstream page in the book, such as page 2 in the example above, the method handles this situation. Specifically, when the user taps on the page layout to reflow from that point, the reflow propagation will only be performed up to the downstream page where the manual reflow was performed. When this occurs, the application 103 may alert the user with a vibrate signal. This reflow behavior allows the user to move back and forth within the book as he or she progressively refines the overall design of the book.

The dynamic reflow system allows the user of a small mobile device to be able to quickly and easily create and edit page layouts for books, such as digital scrapbooks, so that those books can be instantly shared directly from the phone immediately after creation. The application 103 allows users to capture, format, and share important events in their lives, all through the use of a small mobile device. Using this innovative system, rich experiences can be shared with the world in the instant, within the flow of and without disruption to end users' increasingly busy lives.

Although the description has been described with respect to particular embodiments thereof, these particular embodiments are merely illustrative, and not restrictive. For example, although specific details on the user actions to activate controls have been described, other variations are possible. For example, rather than a tap a user may perform any number and/or type of different operations such as gesturing, speaking; or shaking, tilting or otherwise moving the device, etc.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments. For example, a tangible, or non-transitory, medium such as a hardware storage device can be used to store the control logic, which can include executable instructions.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A method for editing a layout of a plurality of pages in a digital book, each page in the book being sequentially numbered and the book having a plurality of layouts and each layout for a page being sequentially numbered, the method comprising:
displaying, on a computing device, two or more pages of the digital book, the two or more pages each having a layout selected from the plurality of layouts;
receiving, by a computer device, an input indication of a layout change for a selected page of the digital book;
displaying, on the computer device, a new layout for the selected page in response to the input indication, wherein the new layout is a next page layout in the sequentially numbered plurality of page layouts; and
propagating, by the computer device in response to the input indication, a new layout for a next page of the digital book that is a downstream page from the selected page, wherein the downstream page is a higher numbered page of the digital book and the new layout is a next layout in the sequentially numbered plurality of page layouts.

2. The method of claim 1, wherein displaying the new layout further comprises displaying a first layout of the sequentially numbered plurality of page layouts when a current layout of the page is a last layout of the sequentially numbered plurality of page layouts.

3. The method of claim 1, wherein propagating the new layout further comprises propagating, by the computer device, a new layout for a next page of the digital book that is a downstream page from the selected page, the new layout being a first layout of the sequentially numbered plurality of page layouts when a current layout of the page is a last layout of the sequentially numbered plurality of page layouts.

4. The method of claim 1, wherein propagating the new layout further comprises incrementing a layout sequence number for the downstream page.

5. The method of claim 1 further comprising animating, by the computing device, the changes in the layout of the pages of the digital book.

6. The method of claim 1 further comprising receiving, by the computer device, an input indication of a layout change for a second selected page of the digital book, wherein the second selected page is a lower numbered page of the digital book and propagating, by the computer device, a new layout for a next page of the digital book that is a downstream page from the second selected page.

7. The method of claim 1, wherein the input indication is a user tap.

8. The method of claim 1, wherein the digital book is a digital scrapbook.

9. An apparatus for editing a layout of a plurality of pages in a digital book, each page in the book being sequentially numbered and the book having a plurality of layouts and each layout for a page being sequentially numbered, the apparatus comprising:
a computing device having a processor and a memory;
an application executed by the processor of the computing device that includes a dynamic reflow component;
the processor configured to display two or more pages of the digital book, the two or more pages each having a layout selected from the plurality of layouts;
the processor configured to receive an input indication of a layout change for a selected page of the digital book;
the processor configured to display a new layout for the selected page in response to the input indication, wherein the new layout is a next page layout in the sequentially numbered plurality of page layouts; and
the processor configured to propagate, in response to the input indication, a new layout for a next page of the digital book that is a downstream page from the selected page, wherein the downstream page is a higher numbered page of the digital book and the new layout is a next layout in the sequentially numbered plurality of page layouts.

10. The apparatus of claim 9, wherein the processor is configured to display a first layout of the sequentially numbered plurality of page layouts when a current layout of the page is a last layout of the sequentially numbered plurality of page layouts.

11. The apparatus of claim 9, wherein the processor is configured to propagate a new layout for a next page of the digital book that is a downstream page from the selected page, the new layout being a first layout of the sequentially numbered plurality of page layouts when a current layout of the page is a last layout of the sequentially numbered plurality of page layouts.

12. The apparatus of claim 9, wherein the processor is configured to increment a layout sequence number for the downstream page to propagate a layout change in the pages of the book.

13. The apparatus of claim 9, wherein the processor is configured to animate the changes in the layout of the pages of the digital book.

14. The apparatus of claim 9, wherein the processor is configured to receive an input indication of a layout change for a second selected page of the digital book, wherein the second selected page is a lower numbered page of the digital book and to propagate a new layout for a next page of the digital book that is a downstream page from the second selected page.

15. The apparatus of claim 9, wherein the input indication is a user tap.

16. The apparatus of claim 9, wherein the digital book is a digital scrapbook.
